(19) United States
(12) Patent Application Publication
(10) Pub. No.: US 2026/0238885 A1
(43) Pub. Date: Aug. 13, 2026

(54) METHOD FOR AUTONOMOUS PRODUCTION OF AN EDITED VIDEO STREAM

(71) Applicant: Studio Automated Sport & Media Holding B.V., Amsterdam (NL)

(72) Inventors: Thomas Pieter Jan BAKKER, Groningen (NL); Tijmen Floris DE HAAN, Amsterdam (NL); Wouter Roel UIJENS, Utrecht (NL); Radu Alexandru COSMA, Amsterdam (NL)

(21) Appl. No.: 19/469,896

(22) PCT Filed: Mar. 28, 2024
(86) PCT No.: PCT/NL2024/050159

§ 371 Date: Sep. 26, 2025

(30) Foreign Application Priority Data
Mar. 28, 2023 (NL) 2034447

(51) Int. Cl. H04N 23/69; G06V 10/82; H04N 23/60; H04N 23/695

(52) U.S. Cl. CPC H04N 23/69; G06V 10/82; H04N 23/64; H04N 23/695

(57) ABSTRACT

The disclosure relates to a computer-implemented method for autonomous production of an edited video stream of a subject area, using a machine-learning model. The machine-learning model is particularly configured and trained to determine, based on an input video frame, a navigation parameter representative of a correction of a frame setting for said input video frame, e.g. a correction to a pan tilt or zoom setting. The method comprises obtaining a first frame for the edited video stream of a first subarea of the subject area, and inputting the first frame to a machine-learning model. Based on the first frame, a navigation parameter is determined that relates to a second subarea of the subject area. A second frame for the edited video stream of the second subarea is obtained, based on the determined navigation parameter.

### FIELD

The invention relates to an autonomous video production of events, for example of sports events.

### BACKGROUND

Popular events like live sports events and concerts are often recorded by various cameras. The video footage recorded by the various cameras is processed into an edited video production, for example for being broadcasted to viewers of the event. The various cameras are conventionally human-operated to capture the event in an appealing way, for example by dynamically directing and zooming the camera to areas of interest of the event. Such video production can be relatively labor-and resource-intensive, and are therefore often not financially feasible for medium and small-scale events.

Automated video production systems can be used to reduce the overall video production costs. Known automated video production systems typically involve a stationary overview camera that records an overview video of the event, wherein automated detection methods are employed for automatically detecting features of interest within the overview video, and extracting subframes from the overview video that depict the features of interest. Features in the area of interest may be automatically detected and tracked by dedicated detection and tracking algorithms. However, such conventional automated feature tracking systems are, compared to human-operated systems, principally poor at appreciating context-dependent situations of events that may be of interest to a human audience. The quality of the resultant video production of such automated methods is in practice therefore often perceived as inferior to conventional human-edited video productions.

### SUMMARY

It is an aim to provide an improved method for automated video production of events. In a more general sense, it is an object to overcome or ameliorate some of the disadvantages of the prior art, or at least provide alternative processes that are more effective than the prior art and which can be used relatively inexpensively. At any rate the present invention is at the very least aimed at offering a useful choice and contribution to the existing art.

According to a first aspect, a computer-implemented method is provided for autonomous production of an edited video stream of a subject area. The edited video may be produced from a video stream of the subject area, e.g. a stationary and/or dynamic video stream of the subject area. The video stream may for example be acquired from one or more cameras that depict the subject area or only parts thereof. The subject area may be a real-world area, such as a scene of an event as depicted by the video stream. The subject area may for example be a sports field, a podium, or parts thereof.

The method comprises obtaining a first frame for the edited video stream of a first subarea of the subject area. The subarea is a part of the subject area, and may be smaller than the subject area. For example, the first frame for the edited video may be a cutout from a video frame of the video stream of the subject area. Alternatively, the first frame may have been obtained from an, e.g. automatedly controlled, camera so directed and zoomed to depict the subarea. The automatedly controlled camera may hence be mechanically and/or optically adjusted for providing an adjustable viewing direction.

The method comprises inputting the first frame into a machine-learning model. The machine-learning model may be pretrained, for example according to training methods described herein.

The method comprises determining, using the machine-learning model, and based on the first frame, a navigation parameter that relates to a second subarea of the subject area. The second subarea may be the same as or different from the first subarea.

The method comprises obtaining a second frame for the edited video stream of the second subarea, based on the determined navigation parameter. Like the first frame, the second frame for the edited video stream may also be a cutout, e.g. a different cutout, from an overview video frame of the video stream of the subject area. Additionally or alternatively, the second frame may be obtained by a physical adjustment of the mechanically and/or optically adjustable camera, e.g. changing the viewing direction and/or optical zoom setting of the camera.

The method hence allows for production of an edited video stream in an iterative manner, for example wherein each frame of the edited video is obtained from another, e.g. preceding or successive, frame. For example, the second frame may be a next frame for the edited video stream, which may be determined from the first, current, frame.

The method enables to automatically produce edited videos, e.g. in real-time, at practically feasible computational costs, as the second frame can be determined based on the first frame and not for example based on a stationary or non-stationary overview video stream of the subject area. Frames of the overview video stream are generally much larger and generally contain more information for determining the appropriate subarea that would be of interest for the edited video than the frames for the edited video themselves. Also, in some situations, an overview video stream may not be available. The inventors have however found that the frames for the edited video contain sufficient information for being used as an input to the machine-learning model for producing a high-quality edited video. By using the frames of the edited video, the computational burden of the method can be kept very low. This particularly can provide a low latency system and method, that enables for real-time or near real-time adjustment of a mechanically and/or optically adjustable camera for obtaining the frames for the edited video.

Furthermore, the machine-learning model can take contextual information into account for inferring the appropriate frame for the edited video, particularly compared to conventional automated feature tracking systems and methods.

The second frame for the edited video stream of the second subarea is determined based on the navigation parameter, which navigation parameter has been determined by the machine-learning model. The method may optionally include determining an adjusted navigation parameter based on the navigation parameter. The navigation parameter may be adjusted, for example by taking secondary indices into account, such as a historic and/or future progression of the navigation parameters over time. This may provide a smooth edited video.

It will be appreciated that the first frame and the second frame may be consecutive frames, but that there alternatively may be other frames between the first frame and the second frame. The first frame may be preceding the second frame in time, but the first frame may also be succeeding the second frame in time. In an example, the first frame and the second frame correspond to the same time instant.

The machine-learning model may particularly be pretrained to, based on an input video frame that is associated with a frame setting such as a tilt setting, a pan setting and/or zoom setting, determine a navigation parameter representative of a correction of said frame setting for said input video frame. The frame setting may particularly include one or more of a tilt setting, a pan setting and a zoom setting, representing a camera view of a real or virtual camera that acquires the associated video frame. The machine-learning model may accordingly be trained to receive the input frame, and to infer therefrom the associated frame setting. The machine-learning model can be configured to output a correction to the frame setting associated with the input frame, that would make the input frame more appropriate for the scene depicted by the input frame.

Hence, the first aspect may more particular provide a computer-implemented of a subject area, comprising: providing a pre-trained machine-learning model configured for receiving an input video frame that is associated with a frame setting such as a pan setting, a tilt setting and/or zoom setting, wherein the pre-trained machine-learning model is pre-trained to determine, based on the input video frame, a navigation parameter representative of a correction of the frame setting for said input video frame; obtaining a first frame for the edited video stream of a first subarea of the subject area; inputting the first frame into the pre-trained machine-learning model; determining, by the pre-trained machine-learning model, based on the first frame, a navigation parameter that relates to a second subarea of the subject area; and obtaining a second frame for the edited video stream of the second subarea based on the determined navigation parameter. Hence, the first frame may be associated with a first frame setting, wherein the determined navigation parameter is representative of a correction to the first frame setting. A second frame setting can be obtained by applying the correction to the first frame setting. The second frame setting may be used for determining an input to a camera system, so as to obtain the second frame. This process can be iteratively repeated for producing frames for the edited video.

Optionally, the first frame and/or the second frame of the edited video stream are obtained by taking a subframe of a frame of a video stream of at least part of the subject area. The subframe may for example be taken from a frame of a stationary or non-stationary overview video stream of the subject area. The subframe may, for example, also be taken from a frame of a non-stationary mechanically and/or optically adjustable, e.g. PTZ, camera. The first frame and/or the second frame may hence be virtual camera projections, e.g. cutouts, of the video stream. The subframes may for example be obtained by cropping frames of the video stream and preferably adjusting, e.g. straightened, a perspective of the crop.

The edited video may include a set, e.g. a time series, of frames, including the first frame and the second frame. Each frame of the edited video may for example be a subframe, e.g. a cutout, from a respective frame of the video of the subject area. The first frame may for example be a subframe of a first frame of an overview video of the subject area, and the second frame may for example be a subframe of a second, different, frame of the overview video of the subject area.

The first frame and the second frame for the edited video stream may be obtained from respective frames of the overview video stream of the subject area. The first frame for the edited video stream of the first subarea may for instance be obtained from a first frame of the overview video stream of the subject area. Similarly, the second frame for the edited video stream of the second subarea may for instance be obtained from a second frame of the overview video stream of the subject area.

Optionally, the first frame and/or the second frame of the edited video stream are obtained by an automatically mechanically and/or optically adjustable camera. Additionally or alternatively, to taking subframes of the stationary overview video of the subject area, each frame of the edited video may be associated with a respective physical setting of a mechanically and/or optically adjustable camera, wherein the mechanically and/or optically adjustable camera may for example only capture part of the subject area

Optionally, the first frame for the edited video stream of the first subarea is not equal to a first frame of the video stream of the subject area. The first frame for the edited video stream of the first subarea may for example be smaller than, e.g. a cutout from, the first frame of the video stream of the subject area.

Optionally, the second frame for the edited video stream of the second subarea is not equal to a second frame of the video stream of the subject area. The second frame for the edited video stream of the second subarea may for example be smaller than, e.g. a cutout from, the second frame of the video stream of the subject area.

Optionally, the first frame has a first frame setting associated therewith and the second frame has a second frame setting associated therewith, and wherein the navigation parameter is representative of an adjustment from the first frame setting to the second frame setting. Hence, the navigation parameter may be a vector that is indicative of a direction and a speed or an amount in which viewing direction and/or field of view of the edited video stream is to be moved, e.g. by virtually or physically steering a camera, starting from the first frame that depicts the first subarea, to depict the second subarea using the second frame. The first frame setting may for example include one or more of a first tilt setting, a first pan setting and a first zoom setting, e.g. of a real or virtual camera. Similarly, the second frame setting may include one or more of a second tilt setting, a second pan setting and a second zoom setting, e.g. of the virtual camera. The navigation parameter may hence provide an adjustment, e.g. a mapping, from the first pan setting to the second pan setting, from the first tilt setting to the second tilt setting and from the first zoom setting to the second zoom setting.

Optionally, the navigation parameter includes one or more of a virtual pan adjustment, a virtual tilt adjustment, and a virtual zoom adjustment.

Optionally, the navigation parameter includes one or more of a mechanical pan adjustment, a mechanical tilt adjustment, and an optical zoom adjustment.

Optionally, the navigation parameter includes an adjustment speed and an adjustment direction. Having the navigation parameter include an adjustment speed and direction may provide for a smoother transition between frames of the edited video, compared to, for example, a navigation parameter that includes absolute adjustment amounts or relative adjustment ratios.

Optionally, the navigation parameter includes one or more of a pan adjustment, a tilt adjustment, and a zoom adjustment. In particular, the navigation parameter includes one or more of a relative pan adjustment, a relative tilt adjustment, and a relative zoom adjustment, with respect to the first frame, for adjusting the first frame setting to the second frame setting. Optionally, one or more of the pan adjustment, the tilt adjustment, and the zoom adjustment is a virtual adjustment. The adjustment is virtual in the sense that no physical movement of a camera is required, but that the adjustment may involve the selection of another cutout from an overview of the subject area instead, i.e. as if (virtually) adjusting a pan, tilt and/or zoom setting of a camera. Hence, the navigation parameter may include one or more of a relative virtual pan adjustment, a relative virtual tilt adjustment, and a relative virtual zoom adjustment, with respect to the first frame. Hence, the first frame and the second frame of the edited video may each be a cutout from a respective frame of the video stream of the subject area.

Optionally, one or more of the pan adjustment, the tilt adjustment, and the zoom adjustment is a physical adjustment. The adjustment is physical in the sense that it involves a physical movement of a camera, e.g. a mechanical pivoting of the camera relative to a base and/or a mechanical movement of one or more lenses for changing optical zoom.

Optionally, the first frame is obtained at a first time instant and the navigation parameter is determined at the first time instant and pertains to a second time instant subsequent in time to the first time instant.

Optionally, the method comprises at the first time instant determining, using the machine-learning model, and based on the first frame, a time-sequence of navigation parameters pertaining to multiple time instants subsequent in time to the first time instant, the time-sequence of navigation parameters particularly including the navigation parameter.

The machine-learning model can hence at a current time instant determine multiple navigation parameters for multiple time instants in the future. A trajectory of future frame settings, in particular tilt, pan, and/or zoom settings, may hence be determined, based on a current frame setting and/or a past frame setting.

Optionally, the machine-learning model is configured for determining the time-sequence of navigation parameters conforming to a predefined progression characteristic. The progression characteristic can be used to provide a smooth edited video with minimal abrupt camera movement. The progression characteristic may accordingly constraint the progression of the navigation parameters of the time-sequence. The progression characteristic may for example impose that a view of a current frame is smoothly accelerated away from, e.g. by having a difference between successive navigation parameters of the time-sequence progressively increase from the current frame. The progression characteristic may for example further impose that a view is smoothly decelerated towards a last frame setting of the time-sequence, e.g. by having a difference between successive navigation parameters of the time-sequence progressively decrease towards a last navigation parameter of the time-sequence.

Optionally, the method comprises determining an adjusted navigation parameter based on the navigation parameter, and further based on at least one further navigation parameter that pertains to the second time instant that has been determined at a time instant preceding the first time instant. Hence, a smooth edited video can be obtained in which sudden changes in viewing direction are effectively smoothed out.

Optionally, the second frame for the edited video stream of the second subarea is obtained based on the adjusted navigation parameter.

Optionally, the adjusted navigation parameter is determined as a weighted average of a plurality of navigation parameters that each pertain to the second time instant and that have each been determined at a time instant preceding the second time instant, particularly wherein the navigation parameters of the plurality of navigation parameters closer in time to the second time instant are given more weight than navigation parameters of the plurality of navigation parameters farther in time from the second time instant. Navigation parameters that have been predicted in the near past pertaining to a future time instant are in practice generally more accurate than navigation parameters that have been predicted in a more distant past pertaining to the future time instant, and can therefore be prioritized more in the determining of the adjusted navigating parameter.

Optionally, the first time instant and the second time instant are spaced apart in time by a time period that is determined to account for a latency of the method, particularly a time delay from a capturing of the first frame to a finalizing of a physical adjustment of a camera associated with the navigation parameter. Particularly for controlling of a mechanically and/or optically adjustable camera, the time delay, e.g. the latency of the system and method, can be substantial. The latency can for example be attributed to several method steps, e.g. one or more of an video frame acquisition time, a data transmission time, a processing time, and a camera adjustment time. The latency can hence be anticipated for, for optimizing the performance of the system. The latency can be determined by measuring or estimating a time delay between steps of the method. The navigation parameter determined at a first, e.g. current, time instant may be for to camera setting pertaining to a second time instant in the future that is separated in time from the first time instant by a time-period that corresponds to the latency. It will be appreciated that the time-delay may span several video frames, i.e. that the latency may be larger than a sampling time-interval of the camera. The navigation parameter may hence pertain to a time instant that is a number of camera sampling time-instances in the future. There may accordingly be time instances between the first and second time instant. Particularly when the video frames for the edited video are captured using a mechanically and/or optically adjustable camera e.g. a PTZ camera, the first time instant and the second time instant may be spaced apart in time by a time period that at least substantially corresponds to a time delay from the capturing of the first frame to a finalizing of a physical adjustment of the camera associated with the navigation parameter.

Optionally, the navigation parameter is determined as a normalized navigation parameter, which is normalized with respect to a field of view of the first frame. For example, one or more of the pan adjustment, the tilt adjustment and the zoom adjustment are determined in normalized form, e.g. with respect to a field of view of the first frame. This way, for example, a machine-learning model can be effectively trained for generating the navigation parameter, particularly because it allows determining a relative pan and tilt adjustment for the second frame irrespective of the field of view, e.g. the zoom setting, of the first frame. The effect that a certain pan and tilt adjustment may have different effects for different zoom settings of the first frame, can hence be efficiently accounted for. The field of view of the first frame may be regarded as an extent of the first subarea depicted by the first frame. The field of view may for example be defined as a dimension of the first frame, such as a height and/or width of the first frame, and/or a viewing angle associated with the first frame. The field of view may be defined by an optical or virtual zoom setting of a camera.

Optionally, the method comprises denormalizing the normalized navigation parameter, e.g. based the field of view of the first frame, and obtaining the second frame for the edited video stream of the second subarea based on the denormalized navigation parameter. For example, the method may comprise denormalizing one or more of the normalized pan adjustment, the normalized tilt adjustment and the normalized zoom adjustment, and obtaining the second frame for the edited video stream of the second subarea based on the denormalized pan tilt and zoom adjustment.

Optionally, the video stream is recorded from a stationary view point by one or more cameras. Recordings of multiple cameras may for example be stitched together to form the video stream.

Optionally, the method comprises calibrating the one or more stationary or nonstationary cameras. The calibrating may particularly include determining a mapping between a coordinate system of the one or more cameras and a coordinate system of the subject area. The calibrating may for example comprise determining an orientation of the one or more stationary cameras relative to the subject area, such as determining an orientation of a pan axis and/or a tilt axis with respect to a horizontal plane and/or a vertical and horizontal spacing between the subject area and the one or more cameras. The calibrating may further include determining a correction mapping for correcting a lens distortion of the one or more cameras. The calibrating may include correlating video frames of respective cameras with one another for stitching the video frames together to form a single video stream.

Optionally, the method comprises obtaining an extended first frame of an extended first subarea of the subject area that is larger than the first subarea by a margin, e.g. a predetermined margin, and determining the navigation parameter based on the extended first frame. Hence, the extended first frame can include additional information compared to the first frame, which can be used for improving the determination of the navigation parameter and, in turn, the second frame. The extended first subarea may be smaller than the subject area, to manage the computational burden. The extended first frame may for example be a cutout from a frame of the video of the subject area. The extended first frame may for example be obtained by zooming out from the first frame, e.g. by a predetermined amount.

Optionally, the margin is asymmetric with respect to the first subarea. Certain regions of the subject area may generally not provide much useful additional information, while other regions generally do. For example, regions above the first frame may generally provide more useful information than regions below the first frame. The margin may hence be asymmetrically arranged about the first subarea, e.g. to have a relatively wide margin above the first frame and a relatively thin margin at the below of the first frame. The asymmetric margin may for example be obtained by zooming out from the first frame and additionally tilting and/or panning the view.

Optionally, the margin is subject area-dependent.

Optionally, the margin is dependent on the navigation parameter, for example dependent on a zoom-value, and/or dependent on the first frame for edited video, for example a size of the first frame relative to a frame of the video stream of the subject area. The margin may for example be relatively small in case the first frame is a relatively large cutout from a frame of the video stream of the subject area, e.g. zoomed-out, and relatively large in case the first frame is a relatively small cutout from a frame of the video stream of the subject area, e.g. zoomed-in.

Optionally, the method comprises labeling the datapoints of the extended first frame for distinguishing between datapoints of the extended first frame that correspond to datapoints of the first frame and datapoints of the extended first frame that correspond to datapoints of the margin. Hence, an appropriate navigation parameter can be obtained, in which it has been automatically accounted for which part of the extended first frame represents first frame and which part does not. Each extended frame may for example include a label channel dedicated for labeling datapoints that are in the margin and/or labeling datapoints that are not in the margin. For example, each frame may include one or more color channels, e.g. a red channel, green channel, and a blue channel, as well as an additional label channel. With the labeling channel, it can be automatically differentiated between parts of the extended frame that form the margin and are accordingly not seen by viewers of the edited video stream, and parts of the extended frame that form the frame for the edited video and are to be seen by the viewers of the edited video stream.

Optionally, the method comprises resampling the, e.g. extended, first frame, and determining the navigation parameter based on the resampled, e.g. extended, first frame. The, e.g. extended, first frame may for example be resampled to a predetermined resolution. An, e.g. extended, first frame of a relatively high resolution may be down-sampled, for example to improve computational efficiency. An, e.g. extended, first frame of a relatively low resolution may be up-sampled.

Optionally, the resampling is such that a nonuniform sampling across the frame is used to obtained the output frame. Regions of the first frame that generally include useful information, such as a center region, may for example be given a higher resolution than regions that include less useful information, such as edge regions of the first frame.

Optionally, the navigation parameter is determined based on a set of frames of the edited video stream that contains only the first frame. It has been found that high quality edited video streams can be obtained by only using the first frame to determine the navigation parameter, and in turn the second frame. This provides a particularly computationally efficient method.

Optionally, the navigation parameter is determined based on a set of frames of the edited video stream that contains at least two frames. Hence, in addition to the first frame, additional frames may be used for determining the navigation parameter, and in turn the second frame. The data based on which the navigation parameter is determined may hence be enriched, by taking into account multiple frames, e.g. preceding frames and/or succeeding frames. It will be appreciated that the preceding frames and the succeeding frames need not be consecutive in time, but that there may be intermediate frames.

Optionally, the set of frames of the edited video stream includes frames that precede the second frame in time. Optionally, the set of frames of the edited video stream includes frames that precede the first frame in time.

Optionally, the set of frames of the edited video stream includes frames that succeed the second frame in time. Optionally, the set of frames of the edited video stream includes frames that succeed the first frame in time. The edited video stream may for example be buffered, for allowing the use of succeeding frames in the determining of the navigation parameter. The overview video of the subject area may be buffered by the same amount. It will be appreciated that the set of frames of the edited video stream may include frames that precede and/or succeed and/or coincide with the first frame in time. The navigation parameter, and the second frame in turn, may hence be determined based on the first frame, and additionally to one or more other frames.

Optionally, the first frame is obtained at a first time instant and the navigation parameter is determined at the first time instant and pertains to a second time instant that succeeds the first time instant, wherein the method comprises at the first time instant determining, using the machine-learning model, and based on the first frame, a time-sequence of navigation parameters pertaining to multiple time instants that succeed the first time instant, the time-sequence of navigation parameters particularly including the navigation parameter; wherein the time-sequence of navigation parameters is determined based on a set of frames of the edited video stream including succeeding frames that succeed the first frame in time; and optionally wherein the time-sequence of navigation parameters is determined based on a set of frames of the edited video stream including preceding frames that precede the first frame in time. In particular, the time-sequence of navigation parameters may include a navigation parameter that pertains to a future time instant with respect to a current time instant. Hence, the edited video stream may be buffered for allowing the succeeding frames of the edited video to be taken into account for determining the time-sequence of navigation parameters, wherein the prediction horizon of the navigation parameters can extend beyond the current time instant into the future. It will be appreciated that the succeeding frames and/or the preceding frames within the buffer may be amended as time progresses from one time instant to the next and a new time-sequences of navigation parameters are determined. The frames within the buffer time window may hence be considered estimate frames. Those frames for the edited video stream that fall out of the buffer as time progresses can be made part of the actual edited video that is for example directly broadcasted to a viewer.

Optionally, the method comprises, after determining the navigation parameter, adjusting the navigation parameter in accordance with a smoothing criterium, and obtaining the second frame for the edited video stream based on the adjusted navigation parameter. A post-processing step may for example be provided, in which the determined navigation parameter is compared to preceding and/or succeeding navigation parameters, and adjusted accordingly. For instance, some navigation parameters may be smoothed-out. Also, the navigation parameter may be adjusted in accordance with consecutive frames and/or navigation parameters to provide a smooth video.

Optionally, the determined navigation parameter is adjusted based on a set of navigation parameters that includes navigation parameters that precede the determined navigation parameter in time and/or navigation parameters that succeed the determined navigation parameter in time. The determined navigation parameter may particularly be adjusted based on a set of navigation parameters that includes navigation parameters that succeed the determined navigation parameter in time, for example to allow for anticipation of large changes of the navigation parameters. If a large succeeding navigation parameter is observed for a succeeding frame, the navigation parameter may be adjusted towards said large succeeding navigation parameter in anticipation thereof. Hence a large change that would have been caused by the large succeeding navigation parameter could be mitigated by adjusting the navigation parameter accordingly, thus creating a smooth edited video.

Optionally, the method comprises determining a navigation trend based on said set of navigation parameters, and adjusting the navigation parameter in accordance with the determined navigation trend.

Optionally, the navigation parameter is determined by a trained machine-learning model, particularly an end-to-end artificial neural network. The machine-learning model may for example be a convolutional neural network or a transformer deep learning architecture. The machine-learning model may be end-to-end in that it determines the navigation parameter directly based on the first frame, without requiring additional computational steps.

According to a second aspect, a computer-implemented method is provided for autonomous production of an edited video stream from a video stream of a subject area, comprising inputting a first frame of the edited video of a first subarea of the subject area into a model, particularly a machine-learning model; having the model determine, based on the inputted first frame, a navigation parameter that relates to a second subarea of the subject area; and obtaining a second frame for the edited video stream of said second subarea. The method may particularly be in accordance with any system or methods as described herein.

It will be appreciated that the term “model” as used herein has a broad meaning, and that functions, equations, algorithms, correspondences, mappings, and the like may be regarded as models.

According to a third aspect, a machine-learning model is provided for autonomous production of an edited video stream of a subject area, for use in a method according to the first and/or second aspect. The machine-learning model may comprise a convolutional neural network or transformer architecture. The machine-learning model may be arranged for receiving a frame for the edited video, e.g. an image, e.g. the first frame, as an input, and generate the navigation parameter as an output. The navigation parameter may for instance include a pan, tilt and zoom value.

According to a fourth aspect, a computer-implemented method of generating a dataset, particularly a training dataset for a machine-learning model such as according to the third aspect. The method comprising providing a video of a subject area; having a human or a trained auxiliary machine-learning algorithm navigate the subject area within the video; and obtaining a curated dataset of navigation parameters therefrom, and/or obtaining a-curated dataset of frames therefrom. The curated data may be human-curated or machine-curated. The navigation of the subject area within the video may involve virtual zooming, virtual panning and/or virtual tilting within the video of the subject area to obtain the curated edited video that is represented by the curated dataset of frames. Each frame of the curated dataset of frames may be associated with a navigation parameter of the curated dataset of navigation parameters. The curated dataset of navigation parameters may for example be obtained from commands of a human-controlled input device, such as joystick or other the like, which control device is operated by the human for adjusting a pan, tilt and/or zoom setting. Optionally, the method involves selecting a subset of frames from the video and having the human navigate the subject area within selected subset of video frames of the video. The human may for example only navigate key frames of the video, for efficient annotation of the data. The curated dataset of navigation parameters may optionally include interpolated navigation parameters that are associated with those frames of the curated video that are between the video frames that have been annotated by the human.

Optionally, the method comprises having the trained auxiliary machine-learning model detect a presence of a predetermined entity of interest in one or more frames of the video; having the trained auxiliary machine-learning model determine a location of the detected entity of interest within the one or more frames of the video; and obtaining the curated dataset of navigation parameters therefrom. For some applications, an auxiliary machine-learning model may be more accurate at detecting and tracking a predetermined entity of interest, such as a person or an object, in a video than a human operator. It may hence be desirable to have the auxiliary machine-learning model generate the training data instead of a human. It will be appreciated that the automated object detection and tracking of an object by the auxiliary machine-learning model per se may hence be used for generating training data for the machine-learning model, but that the eventual production of the edited video by the machine-learning model may not involve the detection and tracking of entities as such. Entity detection and tracking using the auxiliary machine-learning model may be prone to errors in practice, but this could be moderated in the training stage of the machine-learning model. The auxiliary machine-learning model may for example be configured to detect and track a player on a pitch, and may erroneously wander off when it detects other people as well, such as another player, a billboard displaying a human, the audience, etc. In particular, the machine-learning model for the production of the edited video preferably is not a dedicated feature tracking system, i.a. since it would be too error-prone for live streaming of events. Using feature tracking systems at the training stage allows for adjustment of the training data to filter out errors, which is generally undesirable or impractical to do at the production stage of the edited video. Instead of mere object detection and tracking, the machine-learning model is furthermore trained to display a desired frame transition behavior, preferably resembling or exceeding a human camera operator performance.

Optionally, the method of claim, comprises augmenting the curated dataset of navigation parameters by a dataset of augmentations; generating a dataset of frames corresponding to the dataset of augmented navigation parameters; and labeling the dataset of frames with the dataset of augmentations. The dataset of augmentations particularly includes frame setting augmentations, such as tilt augmentations, pan augmentations and zoom augmentations. The dataset of augmentation thus particularly offsets the navigation parameters as curated by a human or auxiliary machine-learning model. By augmenting the curated dataset of navigation parameters this way, the machine-learning model is trained to relate an input frame to a correction applied to the frame setting of the input frame. The machine-learning model can hence be trained to correct the frame setting of its input frame, based on the frame itself. The estimated correction that the machine-learning model learns to generate can subsequently be used for obtaining the second frame.

The curated dataset of navigation parameters may for example be augmented by augmentations that are randomly generated. The augmentations of the dataset of augmentations may for example be subject to normal distribution.

Optionally, the method comprises generating a dataset of frames for the edited video from the video, for example according to a method as described herein or by another method; obtaining a dataset of differences representative of a difference between the generated dataset of frames and the curated dataset of frames; and labeling the dataset of frames with the dataset of differences. The dataset of frames for the edited video from the video may particularly be generated by a machine-learning model as described herein that has been pre-trained. This provides for particularly efficient training.

According to a fifth aspect, a computer-implemented method is provided of training a machine-learning model for autonomous production of an edited video stream from a video stream of a subject area, using a dataset obtained by a method according to the fourth aspect.

Optionally, the machine-learning model is configured for outputting a time-sequence of navigation parameters.

Optionally, the machine-learning model is configured for outputting the time-sequence of navigation parameters conforming to a predefined progression characteristic. The progression characteristic can be used to train the machine-learning model to provide a smooth edited video with minimal abrupt camera movement. The progression characteristic may accordingly constraint the navigation parameters, wherein the constraint is particularly time-dependent. The progression characteristic hence forces the machine-learning model to learn a smooth transition of navigation parameters over time, as opposed to just any sequence of navigation parameters that could lead to a jumpy edited video. The machine-learning model can hence be trained to learn how to smoothly correct the frame settings of the real or virtual camera. The progression characteristic can accordingly be used as a tool to, at the training stage of the machine-learning model, control frame setting adjustment characteristics, which in turn allows for controlling the smoothing behavior of the machine-learning model. It will be appreciated that after training the machine-learning model, no to minimal post-processing may be needed for smoothing the edited video, as the machine-learning model can be trained to provide a smooth edited video. The progression characteristic may for example impose that a view of a current frame is smoothly accelerated away from, e.g. by having a difference between successive navigation parameters of the time-sequence progressively increase from the current frame. The progression characteristic may for example further impose that a view is smoothly decelerated toward a last frame setting of the time-sequence, e.g. by having a difference between successive navigation parameters of the time-sequence progressively decrease towards a last navigation parameter of the time-sequence.

Optionally, the method comprises generating a first training dataset and pretraining the machine-learning model using the first dataset. The method further comprises having the pretrained machine-learning model generate a second training dataset, and training the pretrained machine-learning model using the second dataset.

The first dataset may be generated in various ways, and particularly by providing a video of a subject area; having a human navigate the subject area within the video; obtaining a curated dataset of navigation parameters therefrom; augmenting the curated dataset of navigation parameters by a dataset of augmentations; generating a dataset of frames corresponding to the dataset of augmented navigation parameters; and labeling the dataset of frames with the dataset of augmentations.

The second dataset may be generated by the machine-learning model that has been trained with the first dataset, by having the pre-trained machine-learning model generate a dataset of frames for the edited video from the video of the subject area; obtaining a dataset of differences representative of a difference between the generated dataset of frames and the curated dataset of frames; and labeling the dataset of frames with the dataset of differences. This procedure can be repeated, such that pre-trained machine-learning model can generate further generations of datasets or its own training. Datasets from different generations can optionally be merged to minimize biases in the training data.

Optionally, the method comprises, after training the machine-learning model using the second dataset, having the machine-learning model generate a third dataset; and training the machine-learning model using at least part of the third dataset. The third dataset may be generated by the machine-learning model that has been trained with the first dataset and with the second dataset, comprising having the pre-trained machine-learning model generate a dataset of frames for the edited video from the video; obtaining a dataset of differences representative of a difference between the generated dataset of frames and the curated dataset of frames; and labeling the dataset of frames with the dataset of differences.

According to a sixth aspect, an edited video is provided obtained by a method as described herein.

According to a sixth aspect, a non-transitory computer-readable medium is provided storing instructions that, when executed by one or more processors, cause a device to perform the method as described herein.

According to seventh aspect, a system is provided for autonomous production of an edited video stream of a subject area. The system comprises a camera system; and a processing unit, operatively connected to the camera, configured for executing a method as described herein. The camera system may include a stationary overview camera arranged for recording an overview video stream of the subject area from stationary viewing direction. Additionally or alternatively, the camera system may include a mechanically and/or optically adjustable camera, e.g. a pan-tilt-zoom or PTZ camera, arranged for recording a video stream of the subject area from an adjustable viewing direction. The system may comprise a camera controller operatively arranged between the processing unit and the mechanically and/or optically adjustable camera, the camera controller being arranged for transmitting one or more video frames acquired by the camera to the processing unit, receiving a navigation parameter from the processing unit, and based thereon, mechanically and/or optically adjusting the camera.

For example, the aspect may provide a system for autonomous production of an edited video stream of a subject area, comprising a camera system including an, e.g. stationary, overview camera for obtaining overview video frames of the subject matter and further a mechanically and/or optically adjustable camera for obtaining video frames for the edited video; and a processing unit, operatively connected to the overview camera and the mechanically and/or optically adjustable camera, configured for executing a method as described herein.

Optionally, the processing unit is configured to obtain a first frame of a first subarea of the subject area, the first frame being obtained from the overview camera; inputting the first frame into a machine-learning model; determining, by the machine-learning model, based on the first frame, a navigation parameter that relates to a second subarea of the subject area; and transmitting a control signal representative of the navigation parameter to the mechanically and/or optically adjustable camera, for adjusting the mechanically and/or optically adjustable camera. The overview camera and the mechanically and/or optically adjustable camera may be operated independently, wherein the video frames of the overview camera, e.g. cutouts therefrom, may be used as inputs for the machine-learning model to determine the navigation parameter, while the frames of the mechanically and/or optically adjustable camera may be used for the edited video. The mechanically and/or optically adjustable camera may hence be controlled based on the navigation parameter outputted by the machine-learning model.

It will be appreciated that any of the aspects, features and options described herein can be combined.

### BRIEF DESCRIPTION OF THE DRAWINGS

Embodiments of the present invention will now be described in detail with reference to the accompanying drawings in which:

FIGS. 1-3 show a schematic examples of a system and method for producing an edited video stream;

FIGS. 4A and 4B show a schematic example of a method for producing an edited video stream.

### DETAILED DESCRIPTION

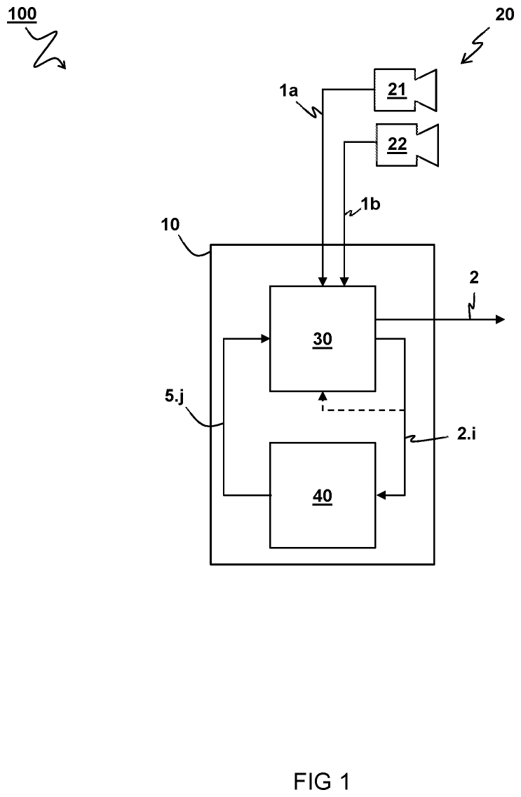

FIGS. 1-3 show schematic examples of a system and method 100 for producing an edited video stream of a subject area. The system 100 comprises a video production unit 10, here arranged for receiving a video stream of the subject area, obtained from a camera system 20 of the system 100. In the example of FIG. 1, the camera system comprises two stationary cameras 21 and 22. In this example, the two cameras 21, 22 each transmit respective video streams 1a, 1b to the video production module 10. The cameras 21, 22 are in this example stationary in practice, and directed such as to acquire a respective video stream 1a, 1b from a fixed stationary point of view of at least part of the subject area, such as of a site of an event, e.g. a sports pitch or music concert. The respective video streams 1a, 1b may be combined to render an overview video stream of the subject area. The video production unit 10 receives the video stream(s) 1a, 1b, and produces an edited video stream 2 based thereon, for example for broadcasting to viewers of the event.

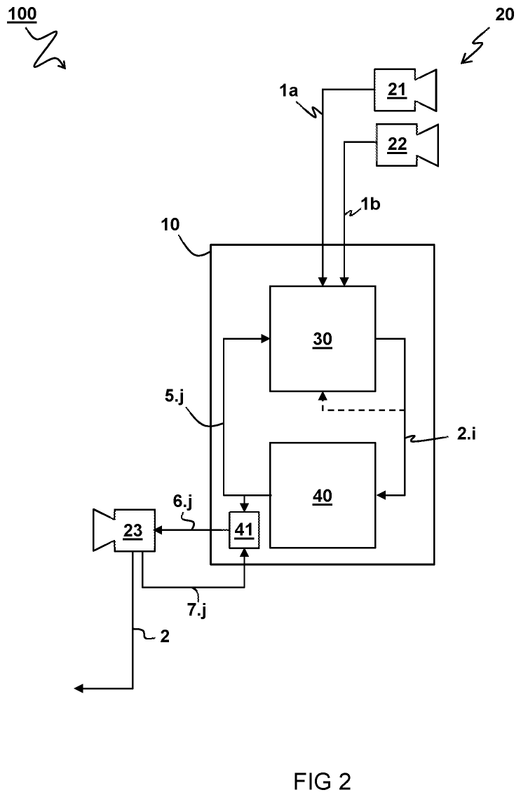

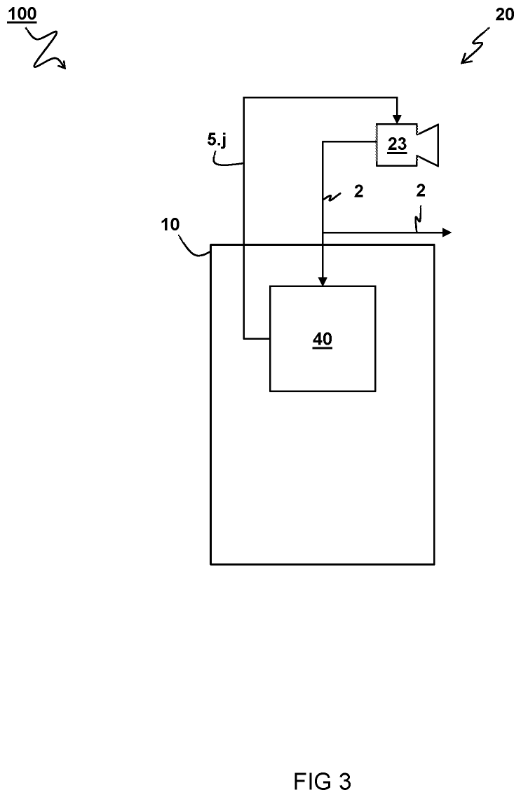

In an alternative arrangement, or in addition to the stationary cameras 21, 22, the camera system 20 can include a mechanically and/or optically adjustable camera 23, e.g. a pan-tilt-zoom camera or PTZ camera, arranged for providing an adjustable view of the subject area. The mechanically and/or optically adjustable camera may for example have a limited field of view and does not capture the entire subject area in one frame. FIG. 2 shows an example of a system 100 having a mechanically and optically adjustable camera 23, in addition to the stationary overview cameras 21 22. FIG. 3 shows an example of a system 100 having only a mechanically and optically adjustable camera 23, excluding a stationary overview camera.

The video production unit 10 in the example of FIGS. 1 and 2 includes a processing module 30. The processing module 30 is here arranged for receiving and processing the video streams 1a, 1b, here received from the cameras 21, 22, for obtaining a video stream of the subject area. The two video streams 1a, 1b may for example be appropriately merged or stitched together, to form a single stream of video frames of the subject area. The video production unit 10 is arranged for producing an edited video stream 2 from the video stream 1, particularly in real-time. The edited video stream 2 may be a time-series of frames that are for example streamed directly to the viewers of the event, or stored in a memory as an edited video for later viewing or further editing. The edited video may for example be used for automated event detection, which in turn can be used to automatically compile a summary video of highlights of the edited video.

The frames for the edited video stream 2 are determined using a generator module 40 of the video production unit 10. The generator module 40 is configured for generating a navigation parameter 5.j based on an input video frame, e.g. an image. The generator module 40, for example including a machine-learning model, such as a convolutional neural network or transformer, is particularly configured for having a first video frame 2.1 for the edited video that depicts a first subarea of the subject area as an input and generating a navigation parameter 5.2 based thereon, for transmission to the processing module 30. The processing module 30 receives the navigation parameter 5.2 generated by the generator, and in turn provides a second frame 2.2 for the edited video that depicts a second subarea of the subject area, associated with the navigation parameter 5.2. The second frame 2.2 for the edited video may in turn be inputted to the generator module 40, for determining a further navigation parameter 5.3, for determining a further frame 2.3 for the edited video. This process can be repeated. The method may hence be an iterative method, in which the frames 2.i for the edited video stream 2 are determined iteratively.

The navigation parameter 5.j may for example be indicative of a coordinate of the subject area, for obtaining a cutout from a video frame of the video stream of the subject area. In this example the navigation parameter 5.2 indicates a relative adjustment from the first frame that depicts the first subarea of the subject area to the second frame that depicts the second subarea of the subject area, such as a vector, indicating a direction and an amount or speed in which view of the edited video stream is to be changed, starting from the first frame, to arrive at the second frame. The navigation parameter may particularly indicate one or more of a relative pan adjustment, a relative tilt adjustment and relative zoom adjustment.

In the example of FIG. 1, the relative adjustment is a relative virtual adjustment, particularly a relative virtual tilt value, relative virtual pan value and relative virtual zoom value, relative to the first frame and with respect to the overview video stream obtained from the stationary cameras 21, 22. It will be appreciated that a tilt may correspond to an adjustment in vertical direction, while a pan may correspond to an adjustment in horizontal direction, or vice versa. In practice, a tilt axis and pan axis may be at an incline with respect to a horizontal plane of the real world. A calibration may hence be employed for providing a mapping between the tilt and pan of the camera and the tilt and pan in the real world. A zoom may change a field of view, e.g. a viewing angle. It will be appreciated that the navigation parameter may alternatively be relative to a frame of the video stream of the subject area.

The processing module 30 may for instance take a subframe from a frame of the video stream 1 of the subject area and output the subframe as a frame 2.i for the edited video stream 2. The subframe may for example only show part of the subject area, particularly a part of the subject area that is most interesting for the viewers. The subframe may for example be obtained by cropping a frame, optionally adjusted for a change in perspective.

The first frame for the edited video may be a subframe from a first frame of the stationary overview video stream of the subject area, and the second frame for the edited video may be subframe from a second frame of the stationary overview video stream of the subject area. It will be appreciated that the first and second frames of the video stream of the subject area need not be successive in time, but that other frames may be interposed therebetween. Similarly, it will be appreciated that the first and second frames of the edited video stream need not be successive in time, but that other frames may be interposed therebetween.

It will also be appreciated that the navigation parameter need not represent a virtual adjustment. Instead, a camera may mechanically tilted and panned, and/or optically zoomed in or out, as shown for the examples of FIG. 2 and FIG. 3. It will also be appreciated that instead of taking subframes of the overview video for generating video frames for the edited video, the frames for the edited video stream may alternatively be obtained by physical adjustment of a camera, e.g. involving an optical zoom, mechanical tilt and mechanical pan adjustment of the camera. Such system may provide increased video quality compared to taking subframes of an overview video frame, but at the cost of increased delays due to physical adjustment of the camera, compared to virtual cropping of an overview video. Video frames acquired by the physically movable camera may also be cropped to some extent, and the frames for the edited video obtained from the physically movable camera can be cutouts as well.

In the exemplary system of FIG. 2, the video frames obtained the overview cameras 21 and 22, particularly cutouts therefrom, are used for determining the navigation parameter 5.j, while the video frames obtained from the mechanically and optically adjustable camera 23 are used for generating the edited video stream 2. The mechanically and optically adjustable camera 23 is accordingly, here, controlled, i.e. mechanically and/or optically adjusted, based on the determined navigation parameter 5.j. Here, the navigation parameter 5.j is in this example converted by module 41, which module 41 may in practice be integrated with the generator module 40, to an appropriate control signal 6.j for controlling the camera 23. The camera 23 in this example transmit feedback signals 7.j back to the mapping module 41, indicative of its settings, e.g. its current pan, tilt and zoom settings.

In the example of FIG. 3, the system 100 does not include a stationary overview camera. In this example, the system 100 only includes a mechanically and optically adjustable camera 23, which acquired video frames are used directly as input to the generator module 40. Based on the video frames of the mechanically and or optically camera 23, the generator module 40 generates a navigation parameter 5.j, that is transmitted toward the camera 23 for mechanically and/or optically adjusting the camera 23 accordingly. Here, the navigation parameter 5.j is directly used as a control signal for the camera 23. The video stream 2 acquired by the camera 23 in this example also directly represents the edited video stream 2. The frames of the edited video stream 2 are transmitted from the camera 23 to the generator module 40. Also, in this example, the camera 23 transmits state information to the generator module 40, particularly including a zoom setting for use in normalizing the navigation parameter.

The navigation parameter 5.j may be generated by the generator module 40 in normalized form, e.g. with respect to frame 2.i inputted to the generator module 40. For example, a tilt value of 0.5 may indicate a tilt upward by an amount corresponding to half a height of the first frame, and a tilt value of −0.5 may indicate a tilt downward by an amount corresponding to half a height of the first frame. A zoom value may optionally be generated on a log scale. For example, a zoom value of 1 may indicate a zoom-in by a factor 2, and a zoom value of −1 may indicate a zoom-out by a factor of 2.

The navigating parameter 5.j may be denormalized, e.g. by the processing module 30, for obtaining a relative adjustment for the virtual or real camera 23 that appropriately depicts the desired subarea of the subject area.

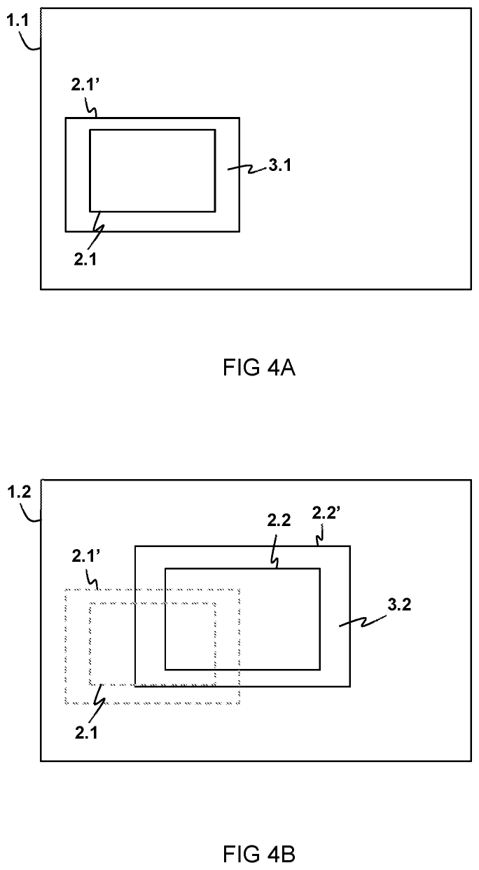

FIGS. 4A and 4B show a schematic example of a method, particularly in conjunction with the exemplary system as shown in FIG. 1. FIG. 4A shows a schematic example of a first frame 1.1 of the video stream of the subject area. Here, the first frame is obtained from a video stream 1.1 of the stationary overview cameras 21, 22, and provides an overview of the subject area, e.g. real world scene. It will be appreciated that the first frame can alternatively be obtained from a mechanically and optically movable camera 23, such as by a system as shown in FIGS. 2 and 3. A first frame 2.1 for the edited video stream is obtained from the first frame 1.1 of the video stream. Here, the first frame 2.1 for the edited video stream is taken as a subframe of the first frame 1.1 of the video stream, e.g. a perspective-adjusted cutout. Hence, the first frame 2.1 for the edited video is in this example associated with a certain coordinate within first frame 1.1 of the video stream, e.g. a virtual pan, virtual tilt, and virtual zoom setting. The first frame 2.1 of the edited video may alternatively be associated with a mechanical pan, mechanical tilt and optical zoom setting, associated with a mechanically and optically movable camera 23. The first frame may be associated with navigation parameter 5.1, that has been generated by the generator module 40.

In the example of FIG. 4A, the first frame 2.1 for the edited video stream is extended by a margin 3.1, hence obtaining an extended first frame 2.1′ for the edited video. The extended first frame 2.1′ is larger than the first frame 2.1, by the margin 3.1. Here, the margin 3.1 is asymmetric with respect to the first frame 2.1 for the edited video. In particular, here, the margin 3.1 is wider below the first frame 2.1 than above the first frame 2.1. Hence, with respect to the first frame 2.1, additional visual information may be present in the extended first frame 2.1′, that can be used for generating an appropriate navigation parameter. Here, more information has been included by the margin 3.1 under the first frame 2.1 than above the first frame 2.1, which may be more data-efficient for certain applications, as most useful visual information is generally expected to be below the first frame 2.1. The margin 3.1 is preferably such that the extended first frame 2.1′ is smaller than the first frame 1.1 of the video of the subject area.

A labeling is assigned to the datapoints of extended first frame 2.1′ for allowing automated differentiation between datapoints of the extended first frame 2.1′ that form the margin 3.1, and datapoints that form the first frame 2.1 for the edited video that is intended to be seen by the viewers. The extended first frame 2.1′ is inputted to the generator module 40, and a navigation parameter 5.2 is outputted. The navigation parameter 5.2 is in this example indicative of a relative adjustment from the first frame 2.1 of the edited video stream to obtain a second frame 2.2 for the edited video stream. Here, the navigation parameter 5.2 indicates a relative virtual tilt adjustment in upward direction, a relative virtual pan adjustment in right direction, and relative virtual zoom-out adjustment, such as a ratio. It will however be appreciated that the navigation parameter may also be indicative of a global coordinate, e.g. with respect to the first or second frame 1.1, 1.2 of the video stream of the subject area.

The second frame 2.2 for the edited video stream can be obtained from a second frame 1.2 of the video stream of the subject area, e.g. by the processing module 30, as if virtually adjusting a camera setting in accordance with the determined navigation parameter 5.2, schematically shown in FIG. 4B. For comparison, the first frame 2.1 is shown in FIG. 4B by dashed lines.

The second frame 2.2 for the edited video may, similar to the first frame 2.1, be a cutout from a second frame 1.2 of the video stream of the subject area. The second frame 2.2 for the edited video may in turn be appended with a margin 3.2 for obtaining an extended second frame 2.2′, which can be used for determining a further navigation parameter and a third frame for the edited video stream, etc. The extended second frame 2.2′ may for example be down-sampled to a predetermined resolution, prior to being inputted to the generator module 40.

Frames for the edited video stream may be determined based on preceding frames of the edited video stream. Hence, a next frame for the edited video stream may be determined based on a current frame and/or one or more previous frames of the edited video. Frames for the edited video stream may also be determined based on succeeding frames of the edited video stream, for example by buffering frames for the edited video stream. Hence, a next frame for the edited video stream may be determined based on a one or more future frames of the edited video that have been buffered. Frames for the edited video stream may also be determined based on a combination of preceding and succeeding frames of the edited video stream.

The generator module 40 in these examples comprise a machine-learning model, such as a deep learning end-to-end convolutional neural network, and/or a transformer architecture, arranged for receiving a frame for the edited video stream, e.g. a digital image, as an input, and based thereon outputting a navigation parameter. However, other machine-learning models can also be used, such as for example support vector machines, decision tree-based learning systems, random forests, regression models, autoencoder clustering, nearest neighbor machine-learning algorithm, etc. In some examples, an alternative regression model can be used instead of an artificial neural network.

Deep learning in a neural network environment can include numerous interconnected nodes referred to as neurons. Input neurons, activated from an outside source, activate other neurons based on connections to those other neurons which are governed by the neural network parameters. A neural network can behave in a certain manner based on its own parameters. Training a deep learning model refines the model parameters, representing, the connections between neurons in the network, such that the neural network behaves in a desired manner (better in the task for which it is intended, e.g. classifying components in material stream).

Deep learning operates on the understanding that many datasets include a hierarchy of features-from low level features (e.g. edges) to high level features (e.g. patterns, objects, etc.). While examining an image, for example, a model starts to look for edges which form motifs which form parts, which form the object being sought. Learned observable features include objects and quantifiable regularities learned by the machine-learning model. A machine-learning model provided with a large set of well classified data is well equipped to distinguish and extract the features pertinent to successful classification of new data.

Optionally, the machine-learning model utilizes a vision transformer architecture (ViT). A vision transformer can partition an input image into a series of patches, serialize each patch into a vector, and map the vector to a smaller dimension e.g. by a matrix multiplication. These vector embeddings can then be processed by a transformer encoder.

Optionally, the machine-learning model utilizes a convolutional neural network. In some examples, deep learning can utilize a neural network segmentation to locate and identify learned, observable features in the data. Each filter or layer of the convolutional neural network architecture can transform the input data to increase the (feature) selectivity and robustness of the model to the data. This abstraction of the data allows the machine to focus on the features in the data it is attempting to classify and ignore irrelevant background information. Deep learning machine models using convolutional neural networks can be used for image analysis.

The machine-learning model is trained based on a first dataset.

The first dataset is in this example obtained from a human-curated dataset of frames for a human-curated edited video. Alternatively or additionally, the first dataset can be obtained from a machine-curated dataset, e.g. from an auxiliary machine-learning model. The human-curated dataset of frames is, here, obtained by providing a video of the subject area, e.g. by cameras 21, 22, and having a human navigate the subject area within said video, e.g. by virtual tilting, virtual panning and virtual zooming within the video of the subject area such as by using a human-controllable input device, such as a joystick or the like, to appropriately depict the subject area. The human-curated edited video can be recorded as a human-curated dataset of frames. The human may navigate the entire video of the subject area, or only a select subset thereof, e.g. only “key” moments in the video. The human-curated edited video may for example include interpolated frames between those key moments. A human-curated dataset of navigation parameters can also be recorded (and optionally interpolated), corresponding to the navigation applied by the human, e.g. the virtual tilting, virtual panning and virtual zooming, to appropriately depict interesting parts of the subject area over time.

The human-curated dataset of navigation parameters is augmented with a dataset of augmentations. The augmentations in this example include pan augmentations, tilt augmentations and zoom augmentations. Hence, here, each navigation parameter includes a pan, tilt and zoom setting, wherein each navigation parameter of the dataset of navigation parameters is offset by a pan augmentation, a tilt augmentation and a zoom augmentation. The augmentations can for instance be randomly generated, such as drawn from a normal distribution. The augmented dataset of frames translates to an augmented edited video that differs in a known way from the human-curated edited video by applied the augmentation. The augmented edited video, i.e. a dataset of frames, is labeled with the dataset of augmentations, creating the first dataset for training the machine-learning model.

The machine-learning model can additionally or alternatively be trained based on a second dataset. The second dataset can be obtained by producing edited video from the video of the subject area. The edited video may be generated in various ways. In this example, the edited video is produced with the machine-learning model that has been pre-trained, for example using the first dataset. This provides a particular efficient training method. Differences between the model-produced edited video, i.e. a model-generated dataset of frames, and the human-curated edited video, i.e. a human-curated dataset of frames, can be determined. Each frame of the model-generated dataset of frames may for example be compared to a corresponding frame of the human-curated dataset of frames, and a difference therebetween, e.g. a relative tilt, relative pan, and relative zoom value, may be stored in the dataset of differences. The model-generated dataset of frames is labeled with the dataset of differences, creating the second dataset for training the machine-learning model. Further generations of datasets can be generated by the pre-trained machine-learning model accordingly. Datasets from different generations can be combined to prevent unwanted biases in the training data.

It will be appreciated that the methods described herein may include computer-implemented steps. All above mentioned steps can be computer implemented steps. Embodiments may comprise computer apparatus, wherein processes are performed in the computer apparatus. The invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program. For example, the carrier may comprise a storage medium, such as a ROM, for example a semiconductor ROM or hard disk. Further, the carrier may be a transmissible carrier such as an electrical or optical signal which may be conveyed via electrical or optical cable or by radio or other means, e.g. via the internet or cloud.

Some embodiments may be implemented, for example, using a machine or tangible computer-readable medium or article which may store an instruction or a set of instructions that, if executed by a machine, may cause the machine to perform a method and/or operations in accordance with the embodiments.

Various embodiments may be implemented using hardware elements, software elements, or a combination of both. Examples of hardware elements may include processors, microprocessors, circuits, application specific integrated circuits (ASIC), programmable logic devices (PLD), digital signal processors (DSP), field programmable gate array (FPGA), logic gates, registers, semiconductor device, microchips, chip sets, et cetera. Examples of software may include software components, programs, applications, computer programs, application programs, system programs, machine programs, operating system software, mobile apps, middleware, firmware, software modules, routines, subroutines, functions, computer implemented methods, procedures, software interfaces, application program interfaces (API), methods, instruction sets, computing code, computer code, et cetera.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A computer-implemented method for autonomous production of an edited video stream of a subject area, comprising:
obtaining a first frame for the edited video stream of a first subarea of the subject area;
inputting the first frame into a machine-learning model;
determining, by the machine-learning model, based on the first frame, a navigation parameter that relates to a second subarea of the subject area; and
obtaining a second frame for the edited video stream of the second subarea based on the determined navigation parameter.

2. The method according to claim 1, wherein the first frame has a first frame setting associated therewith and the second frame has a second frame setting associated therewith, and wherein the navigation parameter is representative of a relative or absolute adjustment from the first frame setting to the second frame setting.

3. The method according to claim 1 or 2, wherein the navigation parameter includes one or more of a pan adjustment, a tilt adjustment, and a zoom adjustment.

4. The method according to any of the preceding claims, wherein the first frame and/or the second frame of the edited video stream are obtained by taking a subframe of a frame of a video stream of at least part of the subject area.

5. The method according to any of the preceding claims, wherein the navigation parameter includes one or more of a virtual pan adjustment, a virtual tilt adjustment, and a virtual zoom adjustment.

6. The method according to any of the preceding claims, wherein the first frame and/or the second frame of the edited video stream are obtained by an automatically mechanically and/or optically adjustable camera.

7. The method according to any of the preceding claims, wherein the navigation parameter includes one or more of a mechanical pan adjustment, a mechanical tilt adjustment, and an optical zoom adjustment.

8. The method according to any of the preceding claims, wherein the navigation parameter includes an adjustment speed and an adjustment direction.

9. The method according to any of the preceding claims, wherein the first frame is obtained at a first time instant and the navigation parameter is determined at the first time instant and pertains to a second time instant subsequent in time to the first time instant.

10. The method according to claim 9, comprising at the first time instant determining, using the machine-learning model, and based on the first frame, a time-sequence of navigation parameters pertaining to multiple time instants subsequent in time to the first time instant, the time-sequence of navigation parameters particularly including the navigation parameter.

11. The method according to claim 10, comprising determining an adjusted navigation parameter based on the navigation parameter, and further based on at least one further navigation parameter that pertains to the second time instant that has been determined at a time instant preceding the first time instant.

12. The method according to claim 11, wherein the second frame for the edited video stream of the second subarea is obtained based on the adjusted navigation parameter.

13. The method according to claim 11 or 12, wherein the adjusted navigation parameter is determined as a weighted average of a plurality of navigation parameters that each pertain to the second time instant and that have each been determined at a time instant preceding the second time instant, particularly wherein the navigation parameters of the plurality of navigation parameters closer in time to the second time instant are given more weight than navigation parameters of the plurality of navigation parameters farther in time from the second time instant.

14. The method according to any of claims 9-13, wherein the first time instant and the second time instant are spaced apart in time by a time period that is determined to account for a latency of the method, particularly for a time delay between a capturing of the first frame and a finalizing of a physical adjustment of the camera that corresponds to the navigation parameter.

15. The method according to any of the preceding claims, wherein the navigation parameter is determined as a normalized navigation parameter, which is normalized with respect to a field of view of the first frame.

16. The method according to claim 15, comprising denormalizing the normalized navigation parameter, and obtaining the second frame for the edited video stream of the second subarea based on the denormalized navigation parameter.

17. The method according to any of the preceding claims, comprising obtaining an extended first frame of an extended first subarea of the subject area that is larger than the first subarea by a predetermined margin, and determining the navigation parameter based on the extended first frame.

18. The method according to claim 17, wherein the margin is asymmetric with respect to the first subarea.

19. The method according to claim 17 or 18, comprising labeling the datapoints of the extended first frame for distinguishing between datapoints of the extended first frame that correspond to datapoints of the first frame and datapoints of the extended first frame that correspond to datapoints of the margin.

20. The method according to any of the preceding claims, comprising resampling the, e.g. extended, first frame, and determining the navigation parameter based on the resampled, e.g. extended, first frame.

21. The method of claim 20, wherein the resampling is such that a nonuniform sampling across the frame is obtained.

22. The method according to any of the preceding claims, wherein the navigation parameter is determined based on a set of frames of the edited video stream that contains only the first frame.

23. The method according to any of claims 1-21, wherein the navigation parameter is determined based on a set of frames of the edited video stream that contains at least two frames.

24. The method according to claim 23, wherein the set of frames of the edited video stream includes frames that precede the second frame in time.

25. The method according to claim 23 or 24, wherein the set of frames of the edited video stream includes frames that succeed the second frame in time.

26. The method according to any of the preceding claims, comprising, after determining the navigation parameter, adjusting the navigation parameter in accordance with a smoothing criterium, and obtaining the second frame for the edited video stream based on the adjusted navigation parameter.

27. The method according to claim 26, wherein the determined navigation parameter is adjusted based on a set of navigation parameters that includes navigation parameters that precede the determined navigation parameter in time and/or navigation parameters that succeed the determined navigation parameter in time.

28. The method according to claim 27, comprising determining a navigation trend based on said set of navigation parameters, and adjusting the navigation parameter in accordance with the determined navigation trend.

29. The method according to any of the preceding claims, wherein the machine-learning model, includes an end-to-end artificial neural network.

30. A computer-implemented method of generating a dataset, particularly a training dataset for a machine-learning model for use in the method according to any preceding claim, comprising:
providing a video of a subject area;
having a human and/or an auxiliary machine-learning model navigate the subject area within the video; and
obtaining a curated dataset of navigation parameters therefrom, and/or
obtaining a curated dataset of frames therefrom.

31. The method according to claim 30, comprising
having the trained auxiliary machine-learning model detect a presence of a predetermined entity of interest in one or more frames of the video;
having the trained auxiliary machine-learning model determine a location of the detected entity of interest within the one or more frames of the video; and
obtaining the curated dataset of navigation parameters therefrom.

32. The method of claim 30 or 31, comprising;
augmenting the curated dataset of navigation parameters by a dataset of augmentations;
generating a dataset of frames corresponding to the dataset of augmented navigation parameters; and
labeling the dataset of frames with the dataset of augmentations.

33. The method according to claim 30, 31 or 32, comprising:
generating a dataset of frames for the edited video from the video, for example according to a method of any of claims 1-29;
obtaining a dataset of differences representative of a difference between the generated dataset of frames and the curated dataset of frames; and
labeling the dataset of frames with the dataset of differences.

34. A computer-implemented method of training a machine-learning model for autonomous production of an edited video stream from a video stream of a subject area, using a dataset obtained by the method of any of claims 30-33.

35. The method according to claim 34, wherein the machine-learning model is configured for outputting a time-sequence of navigation parameters.

36. The method according to claim 35, wherein the machine-learning model is configured for outputting the time-sequence of navigation parameters conforming to a predefined progression characteristic.

37. The method according to claim any of claims 34-36, comprising:
generating a first training dataset, for example according to the method of claim 32 or claim 33, and pretraining the machine-learning model using the first dataset,
having the pretrained machine-learning model generate a second training dataset for example according to the method of claim 33, and training the pretrained machine-learning model using the second dataset.

38. The method according to claim 37, comprising:
after training the machine-learning model using the second dataset, having the machine-learning model generate a third dataset, for example according to the method of claim 33;
training the machine-learning model using at least part of the third dataset.

39. A machine-learning model for autonomous production of an edited video stream of a subject area, trained according to a method of any of claims 34-38.

40. An edited video obtained by a method of any preceding claim.

41. A non-transitory computer-readable medium storing instructions that, when executed by one or more processors, cause a device to perform the method according to any of the preceding claims.

42. A system for autonomous production of an edited video stream of a subject area, comprising:
a camera system; and
a processing unit, operatively connected to the camera, and configured for executing a method according to any of claims 1-38.

43. The system according to claim 42, wherein the camera system includes a stationary overview camera arranged for recording an overview video stream of the subject area from a stationary viewing direction.

44. The system according to claim 42 or 43, wherein the camera system includes a mechanically and/or optically adjustable camera arranged for recording a video stream of the subject area from an adjustable viewing direction.

45. The system according to claim 44, comprising a camera controller operatively arranged between the processing unit and the mechanically and/or optically adjustable camera, the camera controller being arranged for transmitting one or more video frames acquired by the camera to the processing unit, receiving a navigation parameter from the processing unit, and based thereon, mechanically and/or optically adjusting the camera.
